(19) United States
(12) Patent Application Publication
(10) Pub. No.: US 2021/0109926 A1
(43) Pub. Date: Apr. 15, 2021

(54) SYSTEMS AND METHODS FOR STORING AND QUERYING USER EVENT DATA

(71) Applicant: Braze, Inc., New York, NY (US)

(72) Inventors: Zachary MCCORMICK, New York, NY (US); Brian WHEELER, New York, NY (US); Stella KIM, Brooklyn, NY (US)

(21) Appl. No.: 16/597,418

(22) Filed: Oct. 9, 2019

(51) Int. Cl. G06F 16/2457; G06F 16/23; G06F 16/22; G06F 16/2458

(52) U.S. Cl. CPC G06F 16/2457; G06F 16/2477; G06F 16/22; G06F 16/2379

(57) ABSTRACT

Systems and methods for storing and querying user event data record information about user events in data pairs that are tied to specific days of the year. Storing the user event data in this fashion makes it easy to conduct very rapid queries to identify those users who satisfy certain criteria.

### BACKGROUND OF THE INVENTION

The invention is related to systems and methods for enhancing customer engagement. In part, this is accomplished by sending messages to users. The messages could be mobile or browser-based push notifications, text (SMS/MMS) messages, email messages, in-application messages, or an audio recording that is sent to users via a telephony system. Such messages are typically delivered to a user via a user's computing device. The present invention is focused on ways of storing and querying user event data to rapidly identify those users who should receive a particular message.

Companies also often engage a customer engagement service to help manage the delivery of messages to their customers. The customer engagement service can help control the flow and timing of messages to provide the customers with an enjoyable and informative experience. For example, some customers that are highly engaged with a company may wish to receive messages from the company on a frequent basis. Conversely, customers that are not highly engaged with the company may find frequent messages from the company undesirable. The customer engagement service can help determine what individual customers desire, and then manage the flow of messaging to customers based on their individual desires.

The customer engagement service can also cause messages to be delivered to customers at opportune times when the messaging may have the most influence over customer behavior. Similarly, the customer engagement service may know when certain types of message will have the greatest value to customers, and then seek to deliver the messages at those times.

One way that a customer engagement service can determine when to send a message to certain users is by paying attention to events that occur for users. For example, if certain users of a media streaming service frequently use a company's software application to view a particular type of media content, then the customer engagement service may decide to send a message to those users announcing the availability of the same or a similar type of media content.

Unfortunately, tracking the occurrence of multiple different events for a large number of users can be difficult and result in very large databases. Also, conducting a query on those large databases to identify the subset of users who satisfy certain criteria can be time consuming and can consume considerable computer resources.

### BRIEF DESCRIPTION OF THE DRAWINGS

FIG. 1 is a diagram of a communications environment which could be utilized by systems and methods embodying the invention;

FIG. 2 is a diagram of selected elements of a customer engagement service embodying the invention;

FIGS. 3A-3D are diagrams illustrating a first way that user event data can be stored in a database to enable rapid queries that identify users satisfying certain criteria;

FIGS. 4A-4D are diagrams illustrating a second way that user event data can be stored in a database to enable rapid queries that identify users satisfying certain criteria;

FIG. 5 is a flowchart illustrating steps of a first method embodying the invention for storing user event data in a database;

FIG. 6 is a flowchart illustrating steps of a second method embodying the invention for storing user event data in a database; and

FIG. 7 is a diagram of a computer system and associated peripherals which could embody the invention, or which could be used to practice methods embodying the invention.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

Systems and methods embodying the invention can be part of a customer engagement service. As mentioned above, a customer engagement service helps a company interact with its users to enhance the customer experience and to increase the company's business, revenue and/or stature. One of the ways that a customer engagement service assists a company is by helping the company to manage how and when messages are delivered to the company's customers.

The following description refers to “clients” and to “users”. For purposes of this discussion, a “client” would be a client of the customer engagement service. In other words, a company or business that is being assisted by the customer engagement service. “Users” are a client's users, not users of the customer engagement service. The customer engagement service sits between a client and the client's users to manage and orchestrate the delivery of messages sent from the client to its users.

A “message” could take many different forms and be delivered to a user in many different ways. For example, a “message” could be a mobile or browser-based push notification sent to users by a push notification service.

Companies often provide a software application to their customers that the customers install on a computing device such as a laptop computer, a desktop computer, a tablet, a smartphone or a smart TV. The software applications can provide a wide array of functionality or information to customers depending on what types of goods and services the company provides to its customers. For example, an online retailer may provide its customers with a software application that makes it easy for customers to make online purchases. A media company may provide its customers with a software application that makes it easy for the customers to access and watch media content.

The message that is delivered to a user could also be an in-application message (also called an “in-app” message) that is delivered to a user via a client's software application. The in-app messages generated and/or delivered by such a software application could be received by the user in various ways.

A message also could be a text message (SMS/MMS) that is delivered to users via a smartphone or via a text messaging software application. A message also could be a message delivered to a user via a social media service, or via an Over The Top (OTT) messaging service. A message also could be an email message that is delivered to users via standard email service providers. Moreover, a message could be an audio message delivered to a user via a telephony or VOIP service provider, or a video message delivered via similar means.

For purposes of the following description and the appended claims, any reference to sending a “message” to users is intended to encompass any of the different types of messages and delivery channels mentioned above, as well as any message types and delivery means that are developed in the future.

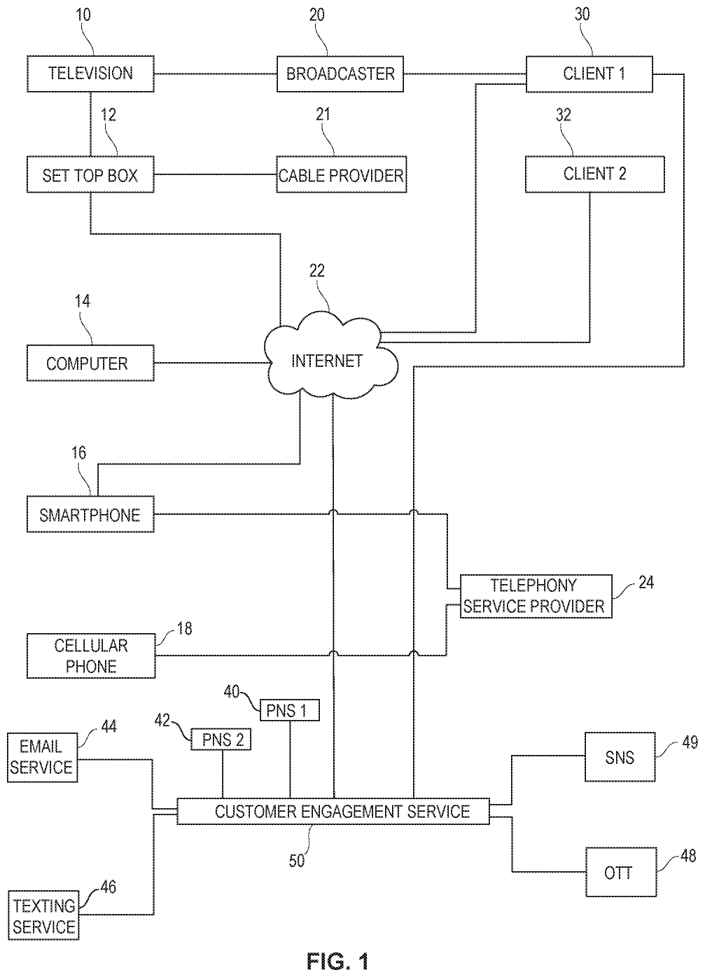

FIG. 1 illustrates a communications environment in which systems and methods embodying the invention could be practiced. As shown in FIG. 1, the communications environment includes client one 30, client two 32 and the customer engagement service 50. Client one 30 and client two 32 are clients of the customer engagement service 50. The clients 30/32 can communicate with the customer engagement service directly, via the Internet 22, or via other means.

Users of the clients 30/32 could utilize the clients' 30/32 services in various ways. For example, if client one 30 is a media company that provides media content to its users, client one 30 could produce media content that is sent via a broadcaster 20 to a client's television 10. That media content could be delivered to the user's television 10 via a set top box 12 that is connected to the user's television and to the Internet 22 and/or a cable service provider 21. In some instances, a software application on the set top box 12 that is provided by client one 30 could be used to deliver the content to the user's television 10.

The same or a different user might have a computer 14 that is connected to the Internet 22. The user could utilize a web browser on the computer 14 to access an Internet website provided by client one 30 that also offers media content. Similarly, a software application provided by client one 30 and that is resident on the user's computer 14 might also be used to access media content provided by client one 30 via the Internet 22.

Yet another user may have a smartphone 16 that is capable of communicating over the Internet 22 and/or via a telephony service provider 24. A software application provided by client one 30 and that is resident on the user's smartphone 16 could be used to access media content provided by client one 30 via the Internet 22 or via the telephony service provider 24.

Still another user might have a cellular telephone 18 that is capable of receiving text messages. This would allow the user of the cellular telephone to receive text messages from client one 30.

FIG. 1 also shows that a first push notification service (PNS) 40 and a second push notification service 42 could be used by the customer engagement service 50 to deliver push notifications to smartphones and/or web browsers. Such messages could be delivered by the push notification services 40/42 to user smartphones via the Internet 22 or via a telephony service provider 24 that provides user smartphone with its native telephony service.

FIG. 1 also shows that an email delivery service 44 could be used by the customer engagement service 50 to send email messages to users. Further, the customer engagement service 50 could use a text messaging service 46 to send text messages to users, or an OTT messaging service 48 to send formatted messages to users. Moreover, the customer engagement service 50 might send a message to users via one or more social networking services 49. Of course, the customer engagement service 50 could utilize any other message delivery service as well to communicate messages to users.

The clients 30/32 in this communications environment could be any sort of client that utilizes a customer engagement service 50 to help them manage engagement with their users. As noted above, a client could be a media broadcaster that produces and sends media content to its users. In other instances, a client could be a retailer whose purchasers are its users. In still other instances, the client could be a service provider, such as a telephony service provider or an Internet service provider. Virtually any business that wishes to send messages to its users could be a client in this environment.

One of skill in the art will appreciate that FIG. 1 only illustrates a very limited number of devices that would be used by users to receive messages from a client, and that could be used to interact with a client. In reality, there would be a very large number of user devices in such a communications environment. Also, a single user could possess and use multiple devices to access a client's services and to receive messages from a client. Thus, the depiction in FIG. 1 should in no way be considered limiting.

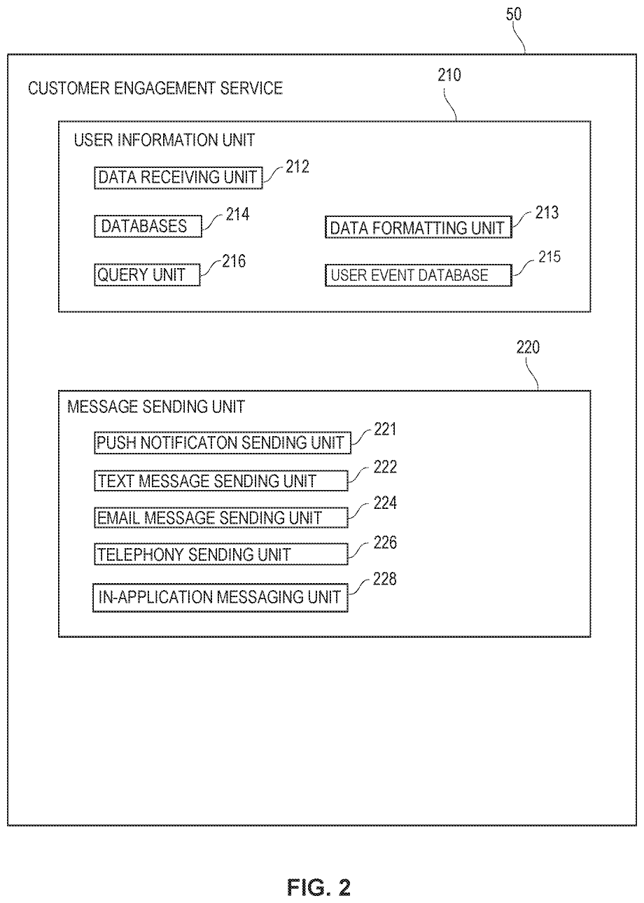

FIG. 2 illustrates selected elements of a customer engagement service 50. The illustration in FIG. 2 is in no way intended to show all elements of a typical customer engagement service 50, and indeed there would typically be many other elements. Likewise, a customer engagement service 50 embodying the invention might not have all the elements illustrated in FIG. 2.

The customer engagement service 50 includes a user information unit 210 that is responsible for receiving and storing information about a client's users, and that is responsible for responding to requests for that stored information. The user information unit 210 includes a data receiving unit 212 that receives various items of information about users. The information could be received from various sources. However, typically a client would provide information about its users to the data receiving unit 212 via various means.

In some instances, the data received by the data receiving unit 212 is directly recorded into one or more databases 214. In other instances, a data formatting unit 213 extracts key pieces of information from the data, formats the data, and records the formatted data in one or more databases. For example, and as will be explained in detail below, the data formatting unit 213 may extract user event data from the information received by the data receiving unit 212. The data formatting unit 213 then formats and stores the user event data in one or more user event databases 215.

For example, in some instances a client may send notifications to the data receiving unit 212 each time that one of the client's users engages with the client in some fashion. For example, if the client is an online retailer, each time that a user makes a purchase from the online retailer, the online retailer could send the data about the purchase made by that user to the data receiving unit 212. As will be explained below, information received by the data receiving unit 212 may satisfy a trigger for causing an in-application message to be presented to a user.

In another example, if the client is a media broadcaster, and one of the media broadcaster's users logs onto a website provided by the media broadcaster to access media content, the media broadcaster could send data about that contact to the data receiving unit 212. The data sent could include an identification of the user, the time that the user accessed the website and an indication of what the user accessed or watched while logged into the website. Similarly, any time that a user accesses a client's website, the client could automatically report that user activity to the data receiving unit 212 of the customer engagement service 50.

In yet another example where the client is a media broadcaster, the media broadcaster could have provided a software application to a user that the user has loaded onto a smartphone or a computing device. The software application could be configured to report the actions that a user takes when using the software application directly to the data receiving unit 212 of a customer engagement service 50. Indeed, in any instance where the client has provided a software application to its users, the software application could be configured to report user activity to the data receiving unit 212 of the customer engagement service 50.

Because clients and software applications that the clients provide to their users all report user activity to the customer engagement service 50, the customer engagement service 50 is able to build a detailed picture of each user, the user's preferences, and the user's typical courses of action.

In addition, because the customer engagement service 50 is tasked by its client with the delivery of messages to the client's users, the customer engagement service 50 is also able to build up a record of how and when individual users react to a sent message. This could include an indication of when a user opens a sent message after delivery, and whether and when the user takes an action in response to receipt of a message. For example, because the data receiving unit 212 is also receiving information from the client regarding a user's contacts with the client, the customer engagement service 50 may learn that shortly after an individual user received a message from the client, the user logged into the client's website. Or that shortly after the user received a message, the user opened a software application provided by the client. For all these reasons, the customer engagement service 50 is able to build detailed user profiles that can be used to predict how individual users will act in certain situations, or how they will respond to certain forms of messaging.

As shown in FIG. 2, the user information unit 210 also includes a query unit 216. The query unit 216 queries the databases 214/215 to obtain various items of information about the users, as will be explained in more detail below. The query unit 216 may also query the user event database to identify those users that satisfy certain criteria.

The customer engagement service 50 also includes a message sending unit 220. The message sending unit 220 is responsible for sending messages to a client's users. As explained above, messages could take many different forms and have many different delivery channels. The message sending unit 220 includes a push notification sending unit 221 that causes mobile or browser-based push notifications to be sent to users via one or more push notification services 40/42, as illustrated in FIG. 1. The push notification sending unit 221 may obtain telephone numbers and push notification service credentials for individual users from the databases 214 with the assistance of the query unit 216. Alternatively, the client may provide that information to the message sending unit 220. The user credential information is then used to cause one or more push notification services 40/42 to deliver a message to the users.

The message sending unit 210 may also include a text message sending unit 222 that causes text-based messages to be sent to users. The text-based messages could be traditional SMS/MMS messages, or messages that are delivered to users via an OTT messaging service or perhaps a social networking service. Information needed to send such text-based messages to users may also be obtained from the databases 214 of the user information unit 210, or that information may be provided by the client. Here again, the message sending unit can enlist the services of one or more text-based message delivery platforms to actually send the message to users.

The message sending unit 220 may also include an email message sending unit 224 that causes email messages to be sent to users. The email message sending unit 224 may obtain email addresses and other information, such as user names, for individual users from the databases 214 with the assistance of the query unit 216, or that information may be provided by the client. The information is then used to send email messages to users. The email messages may be delivered to users by one or more third party email services.

The message sending unit 220 may also include a telephony sending unit 226 that is responsible for delivering audio messages to users via a telephony system. For example, the telephony sending unit 226 could generate an audio recording of a message that is to be delivered to users, or the telephony sending unit 226 could receive such an audio message directly from the client. The telephony sending unit 226 would then obtain information about individual customers from the databases 214 with the assistance of the query unit 216, such as user telephone numbers and user names, or that information could be provided by the client. The telephony sending unit 226 would then enlist the aid of an outside service to deliver the audio message to users via a traditional or VOIP telephony system.

In some instances, the telephony sending unit 226 could generate and operate interactive voice response (IVR) applications to deliver such audio messages to users. Doing so may allow a user to request and receive information or services in addition to the original audio message. If a user does interact with an IVR application, how the user interacts with the IVR application could also be recorded in the databases 214 as additional information about the user.

The message sending unit 220 further includes an in-application messaging unit 228. The in-application messaging unit 228 is responsible for causing messages to be delivered to a user via a client's software application that it provides to its users. For this reason, the in-application messaging unit 228 can interact with an instantiation of a client's software application that is resident on a user's computing device, as will be explained in detail below.

The foregoing and following descriptions refer to “campaigns.” A campaign is a designed to deliver one or multiple messages to one or more users upon the occurrence or satisfaction of one or more trigger conditions. A client or the customer engagement service 50 can set up and configure a campaign to present specific messages to one or more users. The message that is presented could be a predetermined message. Alternatively, the message could be generated using a template that is completed with acquired information. The information that is inserted into a message template could be specific to the user to which the message is presented, or it could be more general in nature.

Part of setting up or configuring a campaign is establishing the trigger conditions that must occur in order for the campaign to deliver a message to one or more users. In some instances, only a single trigger condition needs to be satisfied for a campaign to deliver a message to one or more users. In other instances, multiple trigger conditions must all occur before the campaign will cause a message to be presented to one or more users. As will be explained below, boolean logic can be used to define a set of trigger conditions that must be satisfied before a campaign will cause a message to be sent to one or more users.

A campaign could be implemented by the message sending unit 220 of the customer engagement service. Alternatively, a campaign may be implemented by elements of a software application that is running on a user's computing device.

Information relating to a user's activities may be provided to or reported to the in-application messaging unit 228 by a client or a third-party server. For example, a client's server may report that a user has made a purchase from the client, and that information could be delivered to or reported to the in-application messaging unit 228. The fact that the user made a purchase from the client could satisfy a trigger for a messaging campaign that causes an in-application message to be presented to the user. In this example, a user's activity satisfied a trigger for a message campaign. However, in other instances the receipt of other types of information not related to user activity might also satisfy a trigger of a message campaign.

The way in which a message trigger is satisfied may also be relevant and used to determine what information to insert into a message template to generate a message that will be displayed or played to the user. For example, if the message trigger is the user playing a video, the type of video that the user played may be used to determine how to generate the message that is ultimately generated and displayed or played to the user.

Because the message triggers of a campaign and the message templates can utilize conditional statements and boolean logic-based statements to determine when to deliver a message to a user, and whether and how to generate a message for a user, highly sophisticated personalization for individual users that goes far beyond simply inserting user-specific characteristics or data (such as a user's name or address) into a message template can be achieved.

The foregoing and following descriptions refer to information specific to a user, or user-specific information. Those phrases are intended to encompass simple user characteristic data, such as the user's name and physical characteristics. However, those phrases are also intended to encompass data that is obtained or determined or generated by evaluating conditional statements or boolean logic-based statements within a message template or message trigger. Evaluating the conditional statements and/or boolean logic-based statements may require using simple user characteristics to determine whether and how to generate the message for the user. However, in other instances, no user characteristic data may be needed to evaluate a conditional statement or boolean logic-based statement. Regardless, for purposes of the following discussion, the phrases “information specific to a user” and/or “user-specific information” are intended to encompass data that is obtained or determined or generated by evaluating conditional statements or boolean logic-based statements within a message template or message trigger.

As mentioned above, one way that a customer engagement service can determine when to send a message to a user is by paying attention to user behavior or user event data. User event data is a general term that means that some sort of event has occurred for a user. For example, a user event might be a user opening and using a client's software application. A user event might be a user making a purchase from a client. Another user event might be a user watching any sort of movie using a client's software application, or perhaps watching a comedy movie using the client's software application.

As also mentioned above, the data receiving unit 212 of a customer engagement service 50 can receive information about user events from a wide variety of sources. The client itself might report a user event to the data receiving unit 212. A client's software application installed on a user computing device may report a user event. Alternatively, a third party might provide a notification to the data receiving unit 212 about a user event. That information is then stored in databases 214/215.

The inventors have developed a way of storing user event data in one or more databases that allows for the performance of very rapid queries to determine which users satisfy certain search criteria. Typically, such queries are performed to identify those users that should receive a certain message. The message sending unit 220 is then informed of the identity of the users that should receive the message, and the message sending unit 220 is thereafter responsible for ensuring that the message is delivered to those users that satisfied the search criteria.

A very common type of query keys on three pieces of information. The first piece of information is the identity of a certain type of user event. The second piece of information is a date range. The third piece of information is the frequency of occurrence of the event within the data range. For example, a query could seek to identify those users who opened a client's software application at least two times within the last 5 days. Another query could seek to identify those users who made at least three purchases with a client over the last week. These types of queries are sometimes referred to as “X in Y” queries, where the query seeks to identify those users who experienced a certain type of user event “X” times within the last “Y” days. The inventors developed ways of storing user event data that make it easy to conduct a rapid “X in Y” query to identify those users that experienced a certain type of user event “X” times within the last “Y” days.

Queries can be configured to identify users that have experienced a certain user event an exact number of times within a date range. For example, a query could seek to identify users who have opened a client's software application exactly three times in the last three days. Alternatively, a query could be configured with “less than” or “greater than” qualifiers. For example, a query could seek to identify any users who opened a client's software application at least three times in the last two days. Or, a query could seek to identify users who opened a client's software application fewer than four times in the last two days.

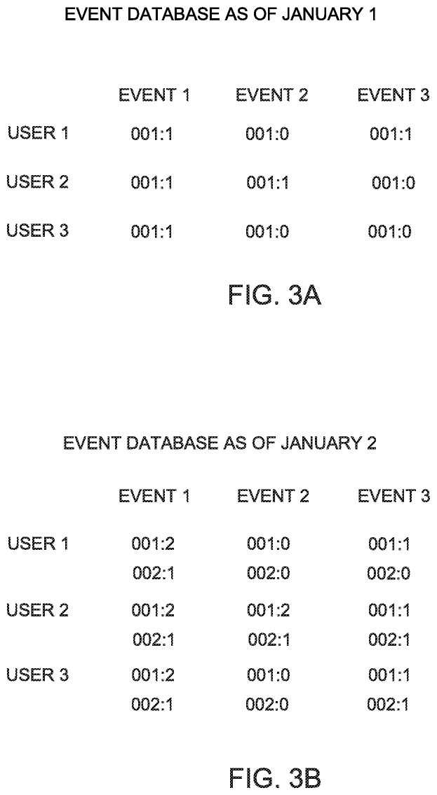

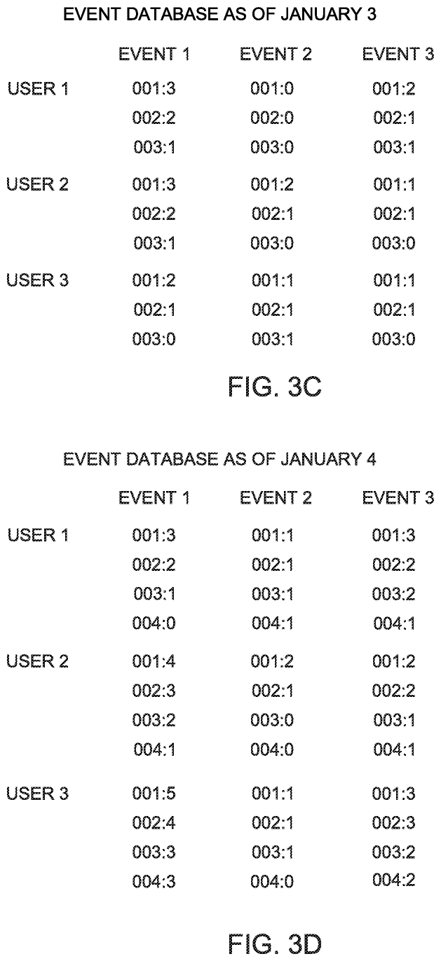

FIGS. 3A-3D illustrate one way that user event data can be stored in a user event database. Data about user events is added to the user event database periodically, and typically once a day. Of course, the user event database could be updated more or less frequently.

FIG. 3A illustrates user event data for three users in connection with three different types of user events. The user events could be virtually anything that is relevant to a particular client. For example, if the client is a media company that provides its users with media content, user event 1 could be a user opening and using the client's software application. User event 2 could be the user watching an episode or any type of comedy television program. User event 3 could be a user paying a fee to watch a comedy movie. These user events could be tracked to determine when to present the user with a message advertising for new comedy television programs or new comedy movies.

The user event examples presented above are just examples; the user events that are tracked for a particular client's users could be virtually any sort of event that is relevant to the goods and services that a client provides to its users. Also, FIGS. 3A-3D illustrate tracking user event data for three types of user events for only three users. In a real-world example of the disclosed and claimed systems and methods, data relating to a large number of different user events could be recorded in a database for a large number of users. Thus, the foregoing and following descriptions should in no way be considered limiting of the invention.

As mentioned above, information about user events is received by the data receiving unit 212 of a customer engagement service 50. A data formatting unit 213 can format user event data and store the user event data in a user event database 215. In the examples provided below, the user event data is formatted and stored as data pairs in the user event database 215. Each data pair includes a first number that represents the day of the year, and a second number that represents the number of times that a certain user event occurred for the user on that day.

FIG. 3A illustrates the data pairs that would be stored in the user event database 315 after a first day. In this example, the first day is January 1 of a particular year, which is why the first number of each data pair is “001”. The second number in each data pair indicates how many times each of the three events occurred for each of three users during the first day of the year. So, for example, event 1 occurred one time during the first day for each of the first, second and third users. Event 2 did not occur for the first and third users during the first day but occurred once for the second user on the first day. Event 3 occurred once during the first day for the first user but did not occur for the second and third users during the first day. The data receiving unit 212 and the data formatting unit 213 may work together to determine how many times each of the events occurred for each of the users, and the data formatting unit 213 would then store the data pairs illustrated in FIG. 3A in the user event database 215.

FIG. 3B illustrates the data pairs that would be stored in the user event database 315 after the second day of the year. There are now two data pairs for each event for each user. The data pairs that begin with “002” indicate the number of times that the three events occurred for each of the users during the second day. However, the data pairs for the first day of the year have also been updated, in some cases, based on the event activity that occurred during the second day of the year.

For example, event 1 occurred once for the first user during the second day, so the data pair for first user for event 1 on the second day reads “002:1”. However, the data pair for the first user for event 1 for the first day has been updated so that the number indicating the number of times the event has occurred is now “2”. This is done to indicate that for the first user, event 1 has occurred twice since the first day—once on the first day, and once on the second day.

The data pair for the first user for event 2 on the second day reads “002:0”, which means event 2 did not occur for the first user on the second day. Because event 2 did not occur for the first user on the second day, there is no need to update the data pair for the first day for event 2.

The data pair for the first user for event 3 for the second day reads “002:0” indicating that event 3 also did not occur for the first user on the second day. Again, because event 3 did not occur for the first user on the second day, there is no need to update the data pair for the first user for event 3 for the first day.

For the second user, the data pair for event 1 for the second day reads “002:1”, indicating the event 1 occurred once for the second user on the second day. Because event 1 occurred once for the second user on the second day, it was necessary to update the data pair for the second user for event 1 on the first day to read “001:2”, which indicates that event 1 has occurred twice for the second user since the first day. The same thing is also true for event 2 for the second user.

The data pair for the second user for event 3 on the second day reads “002:1”, indicating that event 3 occurred once on the second day for the second user. Because of this, the data pair for event 3 on the first day for the second user is updated to read “001:1” indicating that event 3 has occurred once for the second user since the first day.

FIG. 3C illustrates the data pairs that would be stored in the user event database 215 after the third day. The data pair for event 1 for the first user on the third day reads “003:1” indicating that event 1 occurred once for the first user during the third day. The data pair for the first user for event 1 on the second day is updated to read “002:2”, which indicates that event 1 occurred 2 times for the user since the second day—once on the second day and again on the third day. Similarly, the data pair for the first user for event 1 on the first day is updated to read “001:3”, which indicates that event 1 occurred 3 times for the user since the first day—once on the first day, once on the second day and again on the third day.

The data pairs for the first, second and third users for event 1, event 2 and event 3 on the third day are likewise used to adjust the data pair values in certain instances for the first and second days. For example, for the third user for event 2 on the third day, the data pair value reads “003:1”, indicating event 2 occurred once for the third user on the third day. This means the data pair values for the third user for event 2 for the first and second days had to be updated to read “001:1” and “002:1”, respectively, to indicate that event 2 has occurred for the second user 1 since the first day and once since the second day.

When an event occurs for a user during a certain day, it requires that the second value in data pair for all previous days be updated. The second value in each data pair for previous days is updated to become the sum of the number of times the event occurred on that day, plus the number of times the event occurred on all subsequent days. As a result, the second value in each data pair indicates the number of times that the event occurred for the user between that day and the current moment.

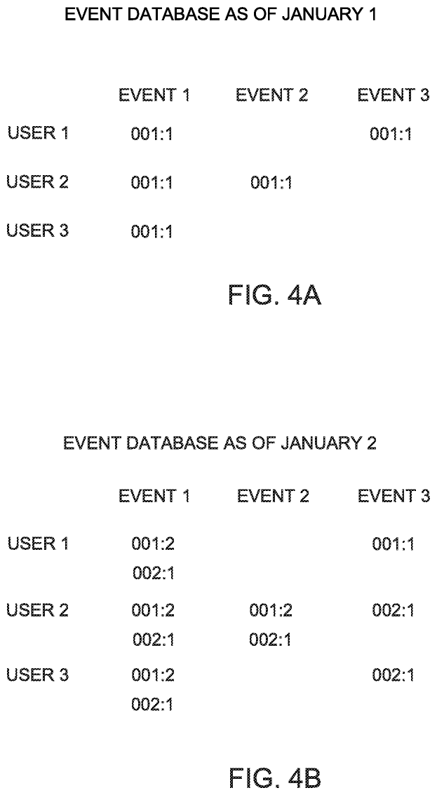

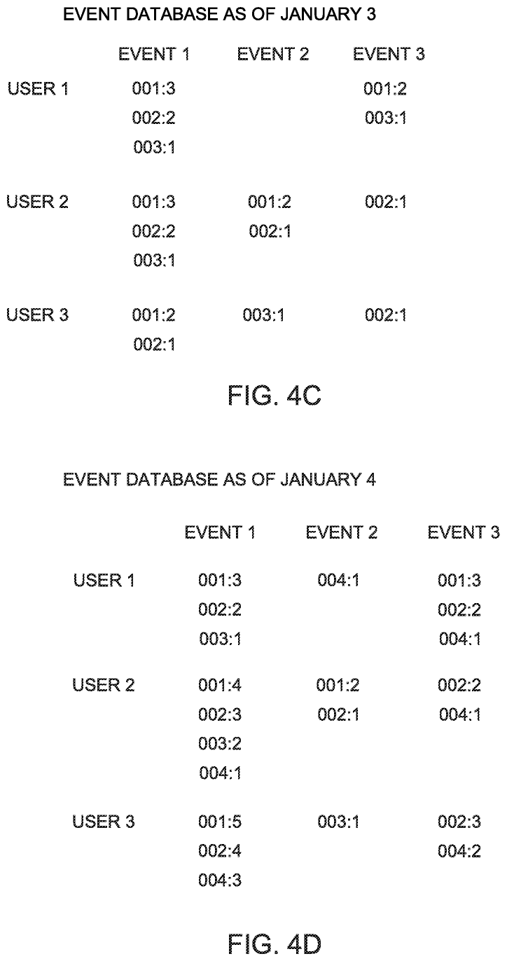

FIG. 4 illustrates the data pair values that would be stored in the user event database after the fourth day. As an example, the data pair value for the third user for event 1 on the fourth day reads “004:3”, indicating that event 1 occurred three times for the third user on the fourth day. Because event 1 occurred three times for the third user on the fourth day, the second value in each previous day's data pairs for event 1 for the third user were updated by adding three to each value. As a result, the data pair value for day 1 for the third user for event 1 reads “001:5”, indicating event 1 has occurred five times for the third user since day 1. Similar changes are made to the second value in the previous day's data pairs for each user for each event when the user experienced an event at least once during the fourth day.

FIGS. 4A-4D illustrate a different way of storing data in the user event database 215. This alternate method is designed to reduce the total amount of data that must be stored in the user event database 215, which in turn can speed up the execution of queries. In this alternate method, no data pair is stored for a user for an event for a particular day if the user did not experience the event on that day. The data pair values that are illustrated in FIGS. 4A-4D reflect exactly the same activity as the data pair values illustrated in FIGS. 3A-3D, so that one can easily see how it is possible to reduce the total amount of data that is stored in the user event database 215.

As is apparent in FIG. 3A, user one did not experience event 2 on the first day. As a result, in FIG. 4A, no data pair value is recorded in the user event database for user one for event 2 on the first day. Likewise, because user two did not experience event 3 on the first day, no data pair value is recorded for user two for event 3 on the first day. Similarly, because user three did not experience events 2 and 3 on the first day, no data pair values are recorded for user three for events 2 and 3 on the first day.

To provide some additional examples, FIG. 4B illustrates that user two experienced event 3 once on day two. As a result, a data pair reading “002:1” is recorded for user two for event three on the second day. However, no entry for the previous day, day one, needs to be updated. Thus, the data pair for day two is the only data pair that is recorded in the user event database 215 for user two for event 3. The same thing applies for user 3 for event 2.

Because user 1 experienced event 1 one time on the second day, a data pair value reading “002:1” is recorded for user one for event 1 on day two. In addition, because there is an existing data pair for user one for event one on day one, the second value in that data pair is updated so that it reflects that user 1 has experienced event 1 twice since day 1. The same things apply for the second and third users for the event 1.

FIG. 4C illustrates that by the end of the third day, because user one did not experience event 2 on days one, two and three, there is still not a data pair recorded in the user event database for user one for event 2. Also, because user three experienced event 2 on only the third day, only one data pair reading “003:1” is recorded in the user event database for user three for event 2.

Although data pairs are not recorded for a user for a particular event on a particular day if the user did not experience the event on that day, the user event database 215 will still contain enough information to infer what happened on any given day. For example, looking at FIG. 4C, because there is only a single entry reading “003:1” for user three for event 2, one can infer that user three did not experience event 2 on the first and second days.

Looking at FIG. 4D, one sees that by the end of the fourth day there are two data pairs recorded in the user event database 215 for user two for event 3 which read “002:2” and “004:1”. Based on these data pairs one can infer that user two experienced event 3 once on day two, once on day four, and that user two did not experience event 3 on days one and three.

Once the user event database 215 has been populated with data, it is possible to rapidly query the data to identify those users that satisfy an “X in Y” type query. For example, assume we conduct a query after the end of day four when the user event database 215 has data pairs that are as shown in either FIG. 3D or FIG. 4D. One can query the database to identify those users that experienced event 1 more than four times within the last four days. Such a query would be looking to check the second value in each data pair for each user for any entries over the last four days to determine if any of the second values are more than 4. Such a query could be expressed as (004>4 or 003>4 or 002>4 or 001>4). Running the query against the data pairs for event 1 for each of the three users would identify only user 3 as having experienced event 1 more than four times in the last four days.

If the data in the user event database 215 is stored as illustrated in FIGS. 3A-3D, it is possible to issue very simple queries to identify users that satisfy an “X in Y” type condition. Because data pairs are recorded for each day, and because each of the data pairs for previous days are updated each day that a user experiences an event, the same query could be accomplished by determining the number of the day that is four days ago, which in this case is day one. Then querying only for the value of day one's data pair. For example, the query would be expressed as (001>4). This query would also identify only the third user has having experienced event 1 more than four times in the last four days.

If one wanted to query the event user database to identify users who experienced event 1 more than two times in the last three days, one first determines the number of the day that is three days ago, which is day two. One then queries the second value in each user's data pair for day two for event 1 to identify those users who have a day two value for event 1 that is greater than 2. The query could be expressed as (002>2). This query would identify both users two and three as satisfying the criteria.

This simplified query technique would not work if the data is recorded in the user event database 215 as illustrated in FIGS. 4A-4D because there will not likely be an entry for each user for each event for all days. As a result, if one attempts to query for a data value for a day where there is simply no data pair entry for a user, the query would fail, even if the user satisfies the query criteria. When the data is stored as illustrated in FIGS. 4A-4D, the first query method described above must be used, where one queries for the value of all previous days within the criteria time period.

Queries are not limited to checking for just those users that have experienced a single type of event a certain number of times over a certain period of time. One can query for multiple conditions. For example, one can query the database to identify those users that have experienced event 1 more than twice in the last three days and that also have experienced event 3 more than once in the last four days. Indeed, complex queries can be formulated and quickly run to identify users that satisfy multiple different “X in Y” conditions.

FIGS. 3A-3D and 4A-4D illustrate a user event database 215 that includes information about multiple users and multiple events. However, databases that embody the invention need not be configured in exactly this way. In some embodiments, a single user event database could contain information about only a single event for a plurality of users. The single event database would include data pairs indicating which days and how often multiple users experienced the single event.

Similarly, a single database could include information about when and how often a single user experiences multiple different events. The single user database would include data pairs for a single user for multiple different types of events over multiple different days.

The data recorded in a user event database 215 could be continuously added to the user event database 215, each time that information about a user event is received, at the end of each day (once it is possible to determine if and how often each user experienced each event that is being tracked on that day), or on some other periodic basis. Regardless, if information is only continuously added to the user event databases, over time this would result in very large databases that would be difficult to quickly query.

In preferred embodiments of the invention, data corresponding to only a predetermined number of days is kept in the user event database 215. For example, data for only the last fifty days could be kept in the user event database 215. On day fifty-one, the data pairs for day fifty-one are recorded in the user event database, and the data from day one is deleted. By keeping only fifty days' worth of data in the user event database 215, the total amount of data is kept in check and it remains possible to quickly query the database. This also reduces the system resources required to store all the data. Of course, the number of days of data that is held in the user event database 215 could vary depending on the nature and purpose of the queries being conducted.

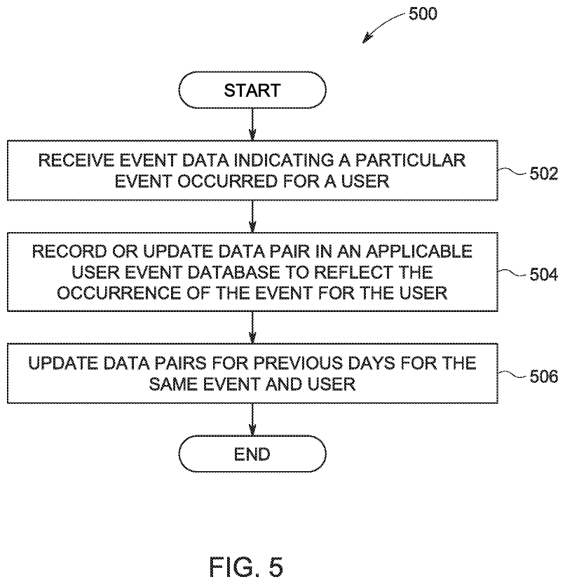

FIG. 5 illustrates steps of a first method of recording data in a user event database 215. The method would be performed by elements of a user information unit 210 of a customer engagement service 50. In this method, information is stored in a user event database each time that information about the occurrence of a user event is received or determined.

The method 500 begins and proceeds to step 502, where the data receiving unit 212 of a user information unit 210 of a customer engagement service 50 receives information indicating that a user event occurred for a particular user. In step 504, if this is the first time that the particular event has occurred for the user during the current day, a data formatting unit 213 records a new data pair representing the occurrence of the event for the user in a user event database 215. If this event has already occurred for the user at least once earlier in the day, then in step 504 the data formatting unit 213 updates the data pair for the event that was previously recorded in the user event database 215 to reflect that the event has occurred again. For example, if the event has already occurred twice for the user during the current day, and the event occurs a third time, step 504 would involve updating the second value in the data pair for the event for this user to be a “3” instead of a “2”.

In step 506, the data formatting unit 213 updates the second value in any data pairs for the same event for this user that were recorded for previous days, as outlined above. This essentially means that for each data pair for a previous day, the second value will be a sum of the number of times the event occurred for the first user on that day, plus the number of times that the event occurred for the first user during any subsequent days, up to and including the current day. The method then ends.

As noted above, a method as outlined in FIG. 5 would be performed each time that the customer engagement service becomes aware that a certain type of event has occurred for a user during the current day. The customer engagement service could become aware of the occurrence of the event because of data that the data receiving unit 212 receives from a third party. Alternatively, the customer engagement service may become aware of the occurrence of the event because of active monitoring performed by the customer engagement service itself.

If a method as outlined above is performed each time that the customer engagement service becomes aware of the occurrence of an event for a user, the system will always essentially be up-to-date with respect to what has transpired for each user. As a result, any “X” in “Y” queries performed will be accurate as the current moment. In addition, system resources will only be engaged to update the user event database(s) if something actually occurs.

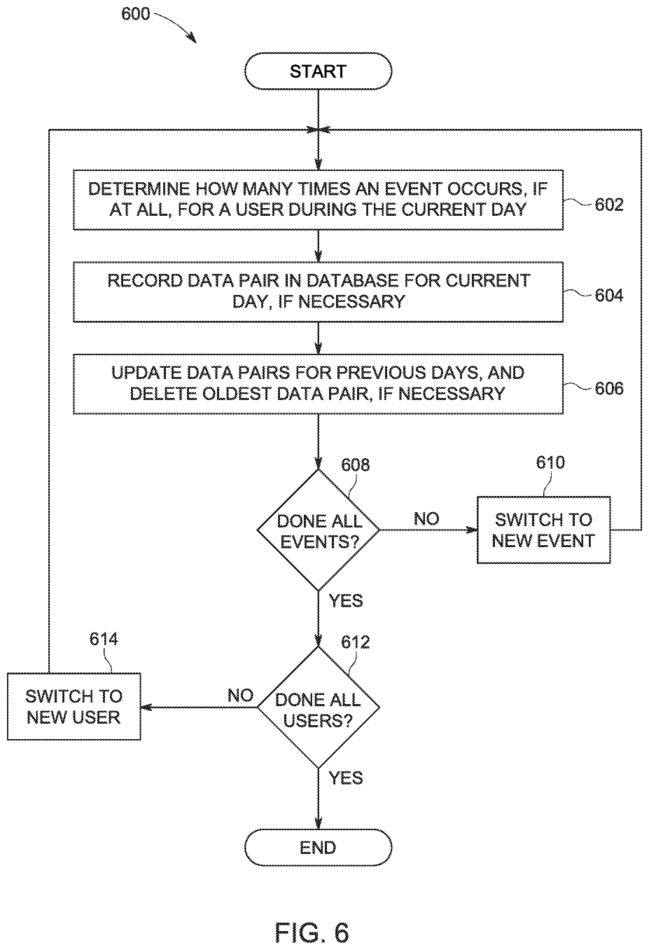

FIG. 6 illustrates steps of a second method for recording information in one or more user event database. This method could be performed on a periodic basis to update the information in the user event database. The method 600 begins and proceeds to step 602 where an element of the user information unit 210 determines how many times that a first event has occurred for a first user during the current day. This determination can be made by reviewing data received by the data receiving unit 212, and which is stored in one or more databases 214. The determining step could be performed by the data receiving unit 212, by the data formatting unit 213, by some other element of the user information unit 210, or by a combination of those elements.

In step 604, the data formatting unit 213 then records a data pair for the current day for the first event for the first user in the user event database 604, if necessary. If data is being recorded in the user event database as illustrated in FIGS. 3A-3D, then a data pair will be recorded for the first user for the first event for the current day, even if the first user did not experience the first event during the current day. If data is being recorded in the user event database 215 as illustrated in FIGS. 4A-4D, a data pair will be recorded in the user event database 215 only if the first user experienced the first event at least once during the current day.

In step 606, the second value in the data pairs for any previous days in the user event database for the first user for the first event are updated, as described above, if necessary. This essentially means that for each data pair, the second value will be a sum of the number of times the first event occurred for the first user on that day, plus the number of times that the first event occurred for the first user on any subsequent days. Of course, if the first user did not experience the first event on the current day, there would be no need to update the second value in the data pairs for any previous days.

In step 608 a check is performed to determine if data for all events being tracked has been recorded for the first user. If not, in step 610 the method switches to the next type of event being tracked, and steps 602-606 are repeated for the next event for the first user. Steps 602-606 would continue to be repeated for the first user for all events being tracked. When the check performed in step 608 indicates that data has been recorded for the first user for all the events being tracked, the method proceeds to step 612.

In step 612, a check is performed to determine if data has been recorded for all the users being tracked. If not, the method proceeds to step 614 where the method switches to the next user being tracked. Steps 602-608 are then repeated for the next user to record data for each event being tracked for the next user. This process repeats until data for the current day has been recorded in the user event database 215 for all users and for all events being tracked. When the check performed in step 612 indicates that data has been recorded for all users, the method ends.

A method as outlined above could be performed once a day, after all data indicating whether users have experienced all of the events being tracked has been received by the user information unit 210 of the customer engagement service 50. As mentioned above, the data recorded in step 604 and the updating that occurs in step 606 could be performed on a single user event database that tracks all users and all events. Alternatively, the recording and updating step could operate on multiple different user event databases.

The present invention may be embodied in methods, apparatus, electronic devices, and/or computer program products. Accordingly, the invention may be embodied in hardware and/or in software (including firmware, resident software, micro-code, and the like), which may be generally referred to herein as a “circuit” or “module.” Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer-usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

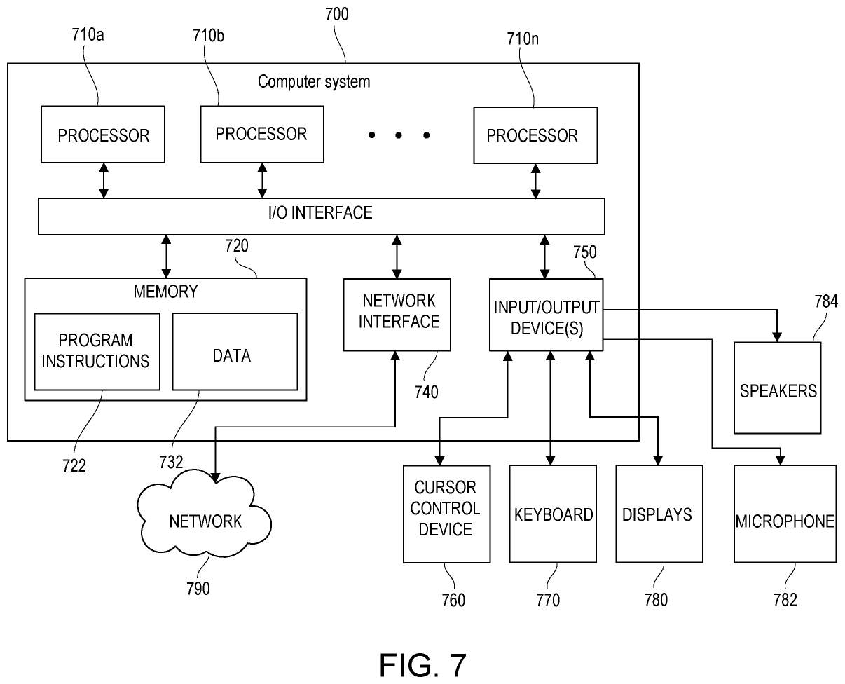

FIG. 7 depicts a computer system 700 that can be utilized in various embodiments of the present invention to implement the invention according to one or more embodiments. The various embodiments as described herein may be executed on one or more computer systems, which may interact with various other devices. One such computer system is the computer system 700 illustrated in FIG. 7. The computer system 700 may be configured to implement the methods described above. The computer system 700 may be used to implement any other system, device, element, functionality or method of the above-described embodiments. In the illustrated embodiments, the computer system 700 may be configured to implement the disclosed methods as processor-executable executable program instructions 722 (e.g., program instructions executable by processor(s) 710) in various embodiments.

In the illustrated embodiment, computer system 700 includes one or more processors 710a-710n coupled to a system memory 720 via an input/output (I/O) interface 730. Computer system 700 further includes a network interface 740 coupled to I/O interface 730, and one or more input/output devices 750, such as cursor control device 760, keyboard 770, display(s) 780, microphone 782 and speakers 784. In various embodiments, any of the components may be utilized by the system to receive user input described above. In various embodiments, a user interface may be generated and displayed on display 780. In some cases, it is contemplated that embodiments may be implemented using a single instance of computer system 700, while in other embodiments multiple such systems, or multiple nodes making up computer system 700, may be configured to host different portions or instances of various embodiments. For example, in one embodiment some elements may be implemented via one or more nodes of computer system 700 that are distinct from those nodes implementing other elements. In another example, multiple nodes may implement computer system 700 in a distributed manner.

In different embodiments, the computer system 700 may be any of various types of devices, including, but not limited to, a personal computer system, desktop computer, laptop, notebook, or netbook computer, a portable computing device, a mainframe computer system, handheld computer, workstation, network computer, a smartphone, a camera, a set top box, a mobile device, a consumer device, video game console, handheld video game device, application server, storage device, a peripheral device such as a switch, modem, router, or in general any type of computing or electronic device.

In various embodiments, the computer system 700 may be a uniprocessor system including one processor 710, or a multiprocessor system including several processors 710 (e.g., two, four, eight, or another suitable number). Processors 710 may be any suitable processor capable of executing instructions. For example, in various embodiments processors 710 may be general-purpose or embedded processors implementing any of a variety of instruction set architectures (ISAs). In multiprocessor systems, each of processors 710 may commonly, but not necessarily, implement the same ISA.

System memory 720 may be configured to store program instructions 722 and/or data 732 accessible by processor 710. In various embodiments, system memory 720 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 720. In other embodiments, program instructions and/or data may be received, sent or stored upon different types of computer-accessible media or on similar media separate from system memory 720 or computer system 700.

In one embodiment, I/O interface 730 may be configured to coordinate I/O traffic between processor 710, system memory 720, and any peripheral devices in the device, including network interface 740 or other peripheral interfaces, such as input/output devices 750. In some embodiments, I/O interface 730 may perform any necessary protocol, timing or other data transformations to convert data signals from one component (e.g., system memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components, such as a north bridge and a south bridge, for example. Also, in some embodiments some or all of the functionality of I/O interface 730, such as an interface to system memory 720, may be incorporated directly into processor 710.

Network interface 740 may be configured to allow data to be exchanged between computer system 700 and other devices attached to a network (e.g., network 790), such as one or more external systems or between nodes of computer system 700. In various embodiments, network 790 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 740 may support communication via wired or wireless general data networks, such as any suitable type of Ethernet network; for example, via telecommunications/telephony networks such as analog voice networks or digital fiber communications networks, via storage area networks such as Fiber Channel SANs, or via any other suitable type of network and/or protocol.

Input/output devices 750 may, in some embodiments, include one or more display terminals, keyboards, keypads, touchpads, scanning devices, voice or optical recognition devices, or any other devices suitable for entering or accessing data by one or more computer systems 700. Multiple input/output devices 750 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 740.

In some embodiments, the illustrated computer system may implement any of the operations and methods described above, such as the methods illustrated by the flowcharts of FIGS. 4-6. In other embodiments, different elements and data may be included.

Those skilled in the art will appreciate that the computer system 700 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of storing and querying user event data, comprising:
(a) determining that a particular event has occurred for a user during the current day;
(b) storing in a database a data pair for the user if the event has not already occurred for the user during the current day, where the data pair includes a first number identifying the current day within the current year and a second number representing the number of times the event has occurred for the user thus far during the current day;
(c) updating a data pair in the database for the user for the event for the current day if the event has already occurred for the user during the current day so that the second number in the data pair indicates the total number of times that the event has occurred for the user during the current day; and
(d) updating the data pairs in the database for the user for the event that are stored in the database for previous days based on how many times the event has occurred for the user during the current day such that the data pair for each previous day has a second number representing how many times the particular event occurred for the user during that day, plus the number of times that the event occurred for the user during any subsequent days up to and including the current day.

2. The method of claim 1, wherein the determining step comprises receiving information from a third party that indicates that the event occurred for the user during the current day.

3. The method of claim 1, wherein the determining step comprises monitoring at least one computer system that relates to the event to determine when the event occurs for the user.

4. The method of claim 1, wherein steps (a)-(d) are repeated for a plurality of users each time that the event occurs for each of the plurality of users.

5. The method of claim 4, further comprising querying the database to identify those of the plurality of users that had the event occur for them X number of times in the last Y number of days, where X and Y are integer numbers.

6. A method of storing and querying user event data, comprising:
(a) determining how many times a particular event occurs, if at all, for a user during a first day;
(b) storing in a database a data pair for the user if the event occurred at least once for the user during the first day, where the data pair for the first day includes a number identifying the first day within the current year and a number representing how many times the event occurred for the user during the first day;
(c) waiting for a day to pass;
(d) determining how many times the event occurs, if at all, for the user during a current day;
(e) storing in the database a data pair for the user for the current day if the event occurred at least once for the user during the current day, where the data pair includes a number identifying the current day within the current year and a number representing how many times the event occurred for the user during the current day; and
(f) updating the data pairs for the user that are stored in the database for previous days if the event occurred at least once for the user during the current day based on how many times the event occurred for the user during the current day such that the data pair for each previous day has a number representing how many times the particular event occurred for the user during that day, plus the number of times that the event occurred for the user during any subsequent days up to and including the current day.

7. The method of claim 6, further comprising repeating steps (c), (d), (e) and (f) each time a new day passes.

8. The method of claim 7, wherein after a predetermined number of days have passed, each time that steps (c), (d), (e) and (f) are repeated the method further comprises deleting the oldest data pair from the database.

9. The method of claim 7, wherein the particular event is a first event, and wherein the method further comprises performing steps (a)-(f) for a second event and repeating steps (c), (d), (e) and (f) each time a new day passes for the second event such that the database includes a plurality of data pairs for the user for the first event and a plurality of data pairs for the user for the second event.

10. The method of claim 7, further comprising performing steps (a)-(f) and repeating steps (c), (d), (e) and (f) each time a new day passes for each of a plurality of users such that the database includes a plurality of data pairs for each of the plurality of users.

11. The method of claim 10, further comprising querying the database to identify those of the plurality of users that had the event occur for them X number of times in the last Y number of days, where X and Y are integer numbers.

12. The method of claim 10, wherein the particular event is a first event, and wherein the method further comprises performing steps (a)-(f) for a second event and repeating steps (c), (d), (e) and (f) each time a new day passes for the second event for each of a plurality of users such that the database includes a plurality of data pairs for each of the plurality of users for the first event and a plurality of data pairs for each of the plurality of users for the second event.

13. The method of claim 12, further comprising querying the database to identify those of the plurality of users that have had the first event occur for them X number of time in the last Y number of days and that have also had the second event occur for them for A number of times in the last B number of days, where X, Y, A and B are integer numbers.

14-26. (canceled)

27. A system for storing and querying user event data, comprising:
a non-volatile memory configured to store database records; and
one or more processors that are configured to perform a method comprising:
(a) determining that a particular event has occurred for a user during the current day;
(b) storing in a database a data pair for the user if the event has not already occurred for the user during the current day, where the data pair includes a first number identifying the current day within the current year and a second number representing the number of times the event has occurred for the user thus far during the current day;
(c) updating a data pair in the database for the user for the event for the current day if the event has already occurred for the user during the current day so that the second number in the data pair indicates the total number of times that the event has occurred for the user during the current day; and
(d) updating the data pairs in the database for the user for the event that are stored in the database for previous days based on how many times the event has occurred for the user during the current day such that the data pair for each previous day has a second number representing how many times the particular event occurred for the user during that day, plus the number of times that the event occurred for the user during any subsequent days up to and including the current day.

28. The system of claim 27, wherein the determining step comprises receiving information from a third party that indicates that the event occurred for the user during the current day.

29. The system of claim 27, wherein the determining step comprises monitoring at least one computer system that relates to the event to determine when the event occurs for the user.

30. The system of claim 27, wherein the one or more processors repeat steps (a)-(d) for a plurality of users each time that the event occurs for each of the plurality of users.

31. The system of claim 30, wherein the method performed by the one or more processors further comprises querying the database to identify those of the plurality of users that had the event occur for them X number of times in the last Y number of days, where X and Y are integer numbers.

32. A system for storing and querying user event data, comprising:
a non-volatile memory configured to store database records; and
one or more processors that are configured to perform a method comprising:
(a) determining how many times a particular event occurs, if at all, for a user during a first day;
(b) storing in a database a data pair for the user if the event occurred at least once for the user during the first day, where the data pair for the first day includes a number identifying the first day within the current year and a number representing how many times the event occurred for the user during the first day;
(c) waiting for a day to pass;
(d) determining how many times the event occurs, if at all, for the user during a current day;
(e) storing in the database a data pair for the user for the current day if the event occurred at least once for the user during the current day, where the data pair includes a number identifying the current day within the current year and a number representing how many times the event occurred for the user during the current day; and
(f) updating the data pairs for the user that are stored in the database for previous days if the event occurred at least once for the user during the current day based on how many times the event occurred for the user during the current day such that the data pair for each previous day has a number representing how many times the particular event occurred for the user during that day, plus the number of times that the event occurred for the user during any subsequent days up to and including the current day.

33. The system of claim 32, wherein the one or more processors repeat steps (c), (d), (e) and (f) each time a new day passes.

34. The system of claim 33, wherein after a predetermined number of days have passed, each time that steps (c), (d), (e) and (f) are repeated the method performed by the one or more processors further comprises deleting the oldest data pair from the database.

35. The system of claim 33 wherein the particular event is a first event, and wherein the method performed by the one or more processors further comprises performing steps (a)-(f) for a second event and repeating steps (c), (d), (e) and (f) each time a new day passes for the second event such that the database includes a plurality of data pairs for the user for the first event and a plurality of data pairs for the user for the second event.

36. The system of claim 33, wherein the method performed by the one or more processors further comprises performing steps (a)-(f) and repeating steps (c), (d), (e) and (f) each time a new day passes for each of a plurality of users such that the database includes a plurality of data pairs for each of the plurality of users.

37. The system of claim 36, wherein the method performed by the one or more processors further comprises querying the database to identify those of the plurality of users that had the event occur for them X number of times in the last Y number of days, where X and Y are integer numbers.

38. The system of claim 36, wherein the particular event is a first event, and wherein the method performed by the one or more processors further comprises performing steps (a)-(f) for a second event and repeating steps (c), (d), (e) and (f) each time a new day passes for the second event for each of a plurality of users such that the database includes a plurality of data pairs for each of the plurality of users for the first event and a plurality of data pairs for each of the plurality of users for the second event.

39. The system of 38, wherein the method performed by the one or more processors further comprising querying the database to identify those of the plurality of users that have had the first event occur for them X number of time in the last Y number of days and that have also had the second event occur for them for A number of times in the last B number of days, where X, Y, A and B are integer numbers.
